(19) United States
(12) Patent Application Publication
(10) Pub. No.: US 2009/0208717 A1
(43) Pub. Date: Aug. 20, 2009

(54) Coextruded multi-layer barrier film having at least one film ply of ethylene-vinyl alcohol copolymer (evoh), method of producing it, and its use

(75) Inventors: Helmut Enzinger, Siegsdorf (DE); Roland Lund, Ubersee (DE)

Correspondence Address: NIXON & VANDERHYE, PC, 901 NORTH GLEBE ROAD, 11TH FLOOR, ARLINGTON, VA, 22203, US

(73) Assignee: BRUCKNER MASCHINEHAU GMBH & CO. KG, SIEGSDORF (DE)

(21) Appl. No.: 11/921,308

(22) PCT Filed: May 18, 2006
(86) PCT No.: PCT/EP2006/004726

§ 371 Date: Nov. 30, 2007

(30) Foreign Application Priority Data
Jun. 2, 2005 (DE) 10 2005 025 472.1

(51) Int. Cl. B32B 27/08; B32B 27/06; B29C 47/06

(52) U.S. Cl. 428/220; 428/339; 264/173.16

(57) ABSTRACT

Barrier film for use in packaging, particularly for the packaging of foods and tobacco, in the form of a multi-layer film based on a biaxially oriented polyolefin film having at least one coextruded functional layer or barrier based on ethylene-vinyl alcohol copolymers (EVOH), which is produced by simultaneous drawing of a coextruded multi-layer primary film at temperatures of 145° C. and below, the ethylene content of the EVOH being below 40 mol % and the thickness of the EVOH layer being less than 5 μm, in particular less than 2 μm, thereby producing values for the oxygen permeability at 23° C. and 75% relative humidity (OTR; ASTM 3985) of better than 10 cm³/m² dbar, preferably better than 5 cm³/m² dbar.

The present invention relates to a barrier film for use in packaging, particularly for the packaging of foods and luxury products and other sensitive goods, in the form of a multi-layer film, the mechanical properties of which are determined substantially by a biaxially oriented film for which a crystallizable polyolefin is used as the film-forming polymer and which also comprises, as the functional layer or barrier, at least one coextruded layer of ethylene-vinyl alcohol copolymers (EVOH).

The invention also relates to a method of producing a film of this type and to the use of a film of this type in packaging, particularly for the packaging of foods and luxury products, wherein the outstanding visual properties, strength properties, barrier properties and also, if appropriate, shrinkage properties of the film are utilized.

Packagings based on plastics films are now an integral part of modern life. Depending on the goods to be packaged, various requirements are placed on plastics films of this type. In plastics films for the packaging of foods and luxury products, the most important properties are those ensuring the shelf life of the packaged food or luxury product in the sales channels and in the home of the end consumer until the food is consumed.

If stringent requirements are placed on packaging films, use is nowadays frequently made in the field of foods and luxury products of polyester-based films (PET; polyethylene terephthalate) which have high strength, good visual properties and can easily be coated with shiny metal foils, especially foils made of aluminum, or with transparent ceramic coatings, especially coatings made of SiOx or AlOx. The thin metal foils or ceramic films impart to the packaging films barrier properties which satisfy stringent requirements, especially with regard to the water vapor transmission rate (WVTR; measured in g/(m² d) or g/(m² 24 h); ASTM E 96) and oxygen transmission rate (OTR; measured in cm³/(m² dbar) or cm³/(m² 24 h) at an atmospheric pressure of 1 bar; ASTM 3985). In order to ensure that the films are weldable or sealable, as is required for producing the packagings, they usually also have an additional outer polyolefin layer, for example a polyethylene layer provided above the metal coating or ceramic coating and made, for example, of HDPE or LDPE. Although these polyester films meet stringent quality requirements, they nevertheless have the drawback, inter alia, that polyester polymers are relatively expensive and have a relatively high density.

Attempts have therefore been made to replace BOPET films which are coated off-line and comprise PVDC (polyvinylidene chloride) or SiOx with polyolefin films which are coextruded in-line, especially polypropylene films. Films of this type are comparatively inexpensive to produce—even as barrier films. However, in order to be able to compete with the more expensive yet high-quality BOPET films, polyolefin films may have no substantial drawbacks either in terms of their visual and strength properties or with regard to their barrier properties.

It is known that in barrier films polyolefin layers, for example layers based on polyethylene, polypropylene or on copolymers thereof, can also be combined with other olefins, comprising layers of ethylene-vinyl alcohol copolymers (EVOH), which are known for their good barrier properties. It is also known that EVOH layers are preferably protected from the environment on both sides of polyolefin layers, as their barrier properties are impaired on ingress of atmospheric moisture, so EVOH layers are normally arranged in the core of a multi-layer film.

It is also normally the case that the barrier properties of an EVOH layer improve if the molar content of vinyl alcohol groups in the EVOH copolymer is as high as possible compared to the content of ethylene groups. However, as the content of polar vinyl alcohol groups in the copolymer rises, incompatibility with non-polar polymers such as polyolefins also rises.

It is also known that biaxial drawing (biaxial orienting) improves the mechanical and visual properties of polyolefin films and that biaxial drawing also improves the barrier properties of EVOH barrier layers.

However, it is also known that polyolefin layers, especially polypropylene layers, and EVOH layers in direct contact do not adhere well and have poor compatibility, and the differing layers crystallize differently during drawing and form their desired optimum properties under differing conditions. In order to improve the compatibility of the layers, it is therefore known to provide specific intermediate layers, generally of specific modified polyolefins, which act as adhesive layers and also simplify, or in some cases even allow, common drawing of polyolefin and EVOH layers.

Nevertheless, in the biaxial orienting of multi-layer polyolefin films comprising EVOH barrier layers, counter-effects still have to be compensated for, as optimum visual and strength properties and good barrier properties are formed under differing conditions. The relevant prior art discloses these problems and pursues differing strategies to produce multi-layer polyolefin films which comprise EVOH barriers and represent an optimum compromise with regard to the achievable desired properties.

U.S. Pat. No. 4,561,920 thus describes a method in which a multi-layer primary film comprising an EVOH core layer and two polyolefin outer layers is biaxially drawn in sequence in that drawing is carried out first in the longitudinal direction (machine direction; MD) in the temperature range of from about 130° C. to 140° C. and then, under altered temperature conditions in the range of from about 150 to 160° C., in the transversal direction (TD). The surface area drawing ratio achieved is in the range of a relatively slight increase in surface area of from just 6 (2×3) to 28 (4×7). It is also stated that although EVOH copolymers having an ethylene content of from 25 to 75 mol % are generally known, for the purposes of the biaxial drawing of barrier films, EVOH having a molar ethylene content of at least 45 mol % should be used to ensure that the EVOH is sufficiently flexible for the drawing. Multi-layer films having, at 20° C. and 0% relative humidity, an oxygen transmission rate (OTR) in the range of from 12 to 13 cm³/m² d were obtained.

EP-A-0 311 293 describes a similar method in which a similar film is also biaxially drawn in sequence, with a higher increase in surface area, by 35 to 70 times, the drawing being carried out in the MD at temperatures in the range of from 140 to 150° C. and in the TD in the range of from 160 to 170° C. Again, it is stated that the ethylene content in the EVOH copolymer should be at least 45% so as to provide satisfactory results during drawing.

EP-A-0 688 667 proposes generally carrying out the simultaneous drawing of a multi-layer film which is based on polypropylene and comprises an EVOH barrier layer of a comparable type, the surface area increasing by 49 to 64 times, although not a single embodiment is described, the term “simultaneous drawing” is left undefined and it is not stated under what conditions such drawing is to be carried out or what type of polymer qualities are to be used for the individual layers. Nor is there any detailed information concerning the quality of the film. Overall, EP-A-0 688 667 therefore does not disclose to a person skilled in the art any specific repeatable teaching.

If an attempt is made, starting from the knowledge of the relevant person skilled in the art that specific drawing temperatures have to be adhered to for the biaxial drawing of polypropylene with surface area drawing ratios in the range of from 49 to 64, simultaneously biaxially to orient, in the known suitable temperature window as specified in EP-A-0 688 667, a polypropylene-based multi-layer film comprising an EVOH core layer in which the molar ethylene content is below 40 mol %, tearing of the EVOH layer (formation of a network structure) is observed owing to strain-induced crystallization. If the EVOH layer tears, it is impossible to ensure any good barrier properties, and the overall quality of the film is inadequate. Drawing as in EP-A-0 688 667, using conventional drawing parameters, led in this case to films which were unusable with regard to their visual appearance and barrier.

EP-A-0 758 675 describes specific modified polyolefins which are suitable promoters for adhesion even between EVOH and polyolefin layers. In an example, a multi-layer test film comprising a polypropylene layer having a low ethylene content, an adhesion promoter layer according to the invention and an EVOH layer having an ethylene content of 44 mol % is drawn to examine the adhesive strength sequentially at 80° C., the surface area increasing by just nine times. Apart from details concerning adhesion, no further information is provided about other properties of the test films.

Two more recent patent applications (WO 00/37253 A1 and WO 2004/050353 A2) also describe the biaxial orientation of multi-layer polyolefin films comprising internal EVOH barrier layers.

WO 00/37253 describes a thermoplastic multi-layer biaxially oriented shrink film. The central layer consists of an ethylene-vinyl alcohol copolymer, whereas the outer layers consist of polyethylene homopolymers or copolymers. The multi-layer film is drawn simultaneously, drawing ratios of over 4 being preferred both in the MD and in the TD. In the examples, the drawing ratios are MD×TD 4.5×4.5 or 5×5, corresponding to increases in surface area during drawing by 20.25 times or 25 times.

The use of polyethylene homopolymers or copolymers in the outer layers does not allow a heat-stabilized film to be produced, and the disclosed conditions of the method are not directly transferable to the processing of polypropylene-based films. Furthermore, although it is generally stated that EVOH qualities having ethylene contents in the range of from about 28 to about 48 mol % can be used, all of the examples, as in the previously known prior art, use exclusively an EVOH having an ethylene content of 44 mol %.

WO 2004/050353 describes the production of a multi-layer biaxially sequentially drawn film consisting of a composite of polypropylene, adhesion promoter and EVOH. The composite is coextruded in melt form in the form of layers of uniform width. The film is then drawn first in the longitudinal direction (MD) and then in the transversal direction (TD) using a tenter frame, the temperature during drawing in the MD being in the range of from 110 to 165° C., in particular from 140 to 160° C., and in the MD in the range of from 130 to 180° C., preferably from 140 to 180° C. It is said to be fundamental to the invention that the clips of the frame grasp all five layers jointly and simultaneously during transversal drawing. If merely the EVOH layer is grasped, the EVOH layer will tear and the film become unusable. The end thickness of the EVOH layer of the film produced having the best described oxygen barrier of approx. 5 cm³/m² d at 23° C. and 50% humidity is about 5 μm, use having been made of an EVOH copolymer having an ethylene content of 44 mol %.

The object of the present invention is to provide an improved barrier film based on biaxially oriented polyolefin layers comprising at least one EVOH barrier layer and also a method of producing it, wherein the film should also have, in addition to the described advantageous properties of oriented polypropylene films, improved barrier values, especially with respect to oxygen and aromatic substances, allowing the advantageous barrier properties of EVOH copolymers having a reduced molar content of ethylene to be fully utilized, and wherein the films according to the invention should at the same time be clear and glossy packaging films of the desired strength and having outstanding impermeability to oxygen, water vapor, aromas and odors.

This object is achieved by a film, the basic features and preferred features of which are characterized in claims 1 to 18, by a method of producing a film of this type having the main features according to claims 19 to 21 and by the use of such a film according to claims 22 and 23.

The present invention will be described hereinafter in greater detail, wherein it should also be noted that the prior art discussed at the outset may also be referred to for establishing the technical knowledge of a person of average skill in the art.

Generally, multi-layer films comprise at least one support layer which determines the most important mechanical properties and consists of a film-forming main polymer, external or internal barriers for achieving the desired barrier properties, and outer layers ensuring the imprintability, the coatability or the sealing capacity required for producing closed packages or laminates.

Within the present invention, the following seven-layer arrangement was chosen with the distribution of the layers A/B/C/D/C/B/E, wherein the individual layers A, B, C, D and E will each be described hereinafter in greater detail.

Layer D is the central inner barrier layer and consists of an ethylene-vinyl alcohol copolymer (EVOH). Attached, adjoining the EVOH barrier layer D on either side, are a respective adhesion promoter layer C consisting of a modified polyolefin, especially a modified polypropylene. Attached adjoining the adhesion promoter layer C is a structural layer B consisting of a partially crystalline thermoplastic polyolefin or a blend of partially crystalline thermoplastic polyolefins which were specifically selected or modified in view of the temperature conditions required for the biaxial drawing thereof and are preferably also polyolefin-based materials. The outer layers A and E also consist of partially crystalline thermoplastic polyolefins, although the selection criterion for these is their surface properties after biaxial drawing.

The layer composite is produced in a manner known per se in that the multi-layer melt is coextruded through a flat die and the multi-layer melt thereby obtained is poured onto a chill roll to solidify it. The film is then drawn using a simultaneous drawing unit.

The preferred method for carrying out the simultaneous drawing is drawing the film as a flat film on a simultaneous drawing unit with linear motor operation (LISIM®). The less advantageous methods of simultaneous drawing using a mechanical simultaneous drawing unit (MSO; mechanical simultaneous orienter; with chain operation) and of production as a tubular film by drawing using the BUBBLE or DOUBLE BUBBLE method are, however, also to be included in the scope of the invention.

The tests which led to the present invention revealed that multi-layer composites comprising an EVOH copolymer having an ethylene content of 44 mol % and 48 mol % could easily be drawn simultaneously at settings typical for the simultaneous drawing of BOPP films, but that this yielded films having unsatisfactory OTR values. The true drawing ratios in these tests were in the MD from 8 to 1 and in the TD from 5.5 to 1. The temperatures set were in the preheating zone between 166° C. and 178° C. and in the drawing zone between 155° C. and 160° C., i.e. they corresponded to typical temperature conditions for the production of BOPP films. The concluding heat setting was carried out at 165° C.

The multi-layer composites comprising an EVOH copolymer having an ethylene content of 44 mol % and 48 mol % were highly transparent and did not display any visible structures, although they had a much too high oxygen transmission rate for critical applications.

Multi-layer composites using EVOH having an ethylene content of from 27 to 38 mol % in the barrier layer, which were produced under the above-mentioned conventional conditions, had, on the other hand, a strong network structure indicating that the integrity of the EVOH barrier layer had been destroyed during the biaxial simultaneous drawing test. It was therefore not possible to produce high-quality barrier films under conventional drawing conditions.

For high-quality barrier films, characteristic values are striven for in the range of the following parameter ranges for the most important barrier properties and mechanical and visual properties:

The oxygen transmission rate (OTR; ASTM 3985) at 23° C. and 75% humidity of the film should be less than 8 cm³/(m² dbar) and the thickness of the EVOH barrier layer should not be above 10 μm. The sum of the moduli of elasticity (ASTM D 822) should not exceed 2,000 N/mm² in the longitudinal and transversal directions, and the tensile strength (ASTM D 822) should not exceed 300 N/mm² in the longitudinal and transversal directions. The gloss (ASTM 2457) should be above 80 and the turbidity (ASTM 1003) should be below 5%. The films may also not comprise any network structure.

The inventors have surprisingly found that a film of this type can be obtained if the simultaneous drawing is carried out at temperatures below 145° C. in that, in particular, the material for layers B is chosen accordingly. Under these drawing conditions, multi-layer films comprising an EVOH barrier layer having an ethylene content below 40 mol % and having the desired film properties, in particular having outstanding OTR values of 8 cm³/m² dbar and less, can be obtained. During simultaneous biaxial drawing, strain rates of more than 50%/s, preferably more than 300%/s are applied to prevent tearing (formation of a network structure) of the EVOH layer.

In contrast to the teaching of WO 2004/050353, the method according to the invention, which includes simultaneous drawing at relatively low temperatures, does not require all of the layers of the multi-layer film to be extruded in uniform width and jointly to be grasped with the clips during drawing. On the contrary, it has been found that the free edge process, which is known per se and has basic commercial advantages, may also be used. It has also been found that there may be used a broad range of surface area drawing ratios which, if desired, can also exceed values of 64 or be less than 49. Furthermore, the barrier films can also be produced as shrink films having customized shrinkage properties.

The drawability observed in accordance with the invention without the formation of a network structure in and adjoining the EVOH barrier layer can be explained in terms of a suppression of strain-induced phase transformations and crystallization processes during the drawing at temperatures below 145° C.

Various suitable compositions will be described hereinafter in greater detail, by way of example, with reference to the structure A/B/C/D/C/B/E for the individual layers:

### Inner EVOH Barrier Layer D:

The inner layer D of EVOH copolymer contains at least 50% by weight, preferably 70 to 100% by weight, in particular 80 to <100% by weight, based respectively on layer D, of an ethylene-vinyl alcohol copolymer (EVOH) described hereinafter.

EVOH copolymers are known per se in the art and are produced by the saponification or hydrolysis of ethylene-vinyl acetate copolymers. Especially suitable for the purposes of the present invention are EVOH copolymers having a degree of hydrolysis of from 96 to 99%. The melting point of suitable EVOH copolymers is generally above 150° C. According to the invention, the ethylene content of the EVOH copolymer should also be 40 mol % or less, and the thickness of the EVOH barrier layer should generally be in the range of from 1 to 10 μm, preferably from 1 to 6 μm, in particular from 1 to 3 μm.

### Adhesion Promoter Layer C:

The structural layer B and the EVOH barrier layer D have to be connected via an adhesion promoter layer C. The adhesive layer is therefore provided between the inner ethylene-vinyl alcohol (EVOH) layer and the layer of partially crystalline polyolefins B. The adhesive layer C ensures that the EVOH layer D and layer B are sufficiently tightly connected to each other that both layers D and B can be jointly drawn and the mutual adhesion is preserved while they are jointly being simultaneously oriented on the unit for simultaneous drawing. The adhesive layer is a layer based on modified polyolefins.

The modified polyolefins are based on ethylene polymers or, in particular, the preferred propylene polymers which are propylene homopolymers, propylene copolymers or propylene terpolymers. Propylene copolymers or propylene terpolymers contain predominantly propylene units, preferably at least 80 to 98% by weight, and additional ethylene and/or butylene units in corresponding amounts as comonomers. These polymers are preferably modified with maleic anhydride, optionally also with other carboxylic acid monomers or the esters thereof such as, for example, acrylic acid or the derivatives thereof.

Modified polypropylenes and polyolefins of this type are known per se in the art and are sold, for example, by Mitsui Chemicals under the commercial name Admer® or by Mitsubishi Chemicals under Modic® or by Chemplex under Plexar®, and also as Epilene® by Eastman and as Bynel® by DuPont.

Preferred for the purposes of the present invention are propylene homopolymers or propylene copolymers modified with maleic anhydride (for example, products of the Q series from Mitsui Chemicals), of which the melt indices are in the range of from 1 to 10 g/10 min at 230° C. (ASTM D 1238) and the Vicat softening points are between 110 and 155° C.

The thickness of the adhesive layer C is generally respectively from 0.3 to 5 μm, preferably 0.3 to 3 μm, in particular 0.3 to 2 μm.

### Layer B:

Layer B is a structural layer of the biaxially orientable polyolefin, especially polypropylene, and has to have sufficiently high adhesive strength with respect to the adhesive layer C to preserve the adhesion during simultaneous drawing at temperatures below 145° C.

Suitable for layer C are partially crystalline polyolefins of which the crystallinity is at least 10 to 70%, preferably 30 to 70%, and the melting point at least 110° C.

The polyolefins are preferably based on propylene polymers which are propylene homopolymers, propylene copolymers or propylene terpolymers. Propylene copolymers or propylene terpolymers contain predominantly propylene units, preferably at least 80 to 98% by weight, and additional ethylene and/or butylene units in corresponding amounts as comonomers.

The aforementioned propylene polymers can be used individually or used as blends. Preferably, use is also made of modifiers which allow a drawing temperature below 145° C. The modifiers used are preferably, for example, atactic polypropylene, syndiotactic polypropylene, hydrocarbon resins, ethylene-propylene copolymers, propylene-butylene copolymers, ethylene-propylene-butylene terpolymers, polybutylene, regenerated polypropylene and linear low-density polyethylene (PE-LLD).

Use is preferably made of a propylene polymer having an ethylene content of between 0 and 15% by weight, based on the total polymer. Especially suitable are isotactic propylene polymers having a melting point of from 150 to 170° C. and a melt flow index (measurement DIN 53735 at loading of 21.6 N and 230° C.) from 1.0 to 15 g/10 min. The crystallinity of the propylene polymer is preferably 40 to 70%. The molecular weight distribution of the homopolymer can vary. The ratio of the weight average Mw to the number average Mn is generally between 1 and 15.

It is preferable for the thickness of layers B to be between 3 and 35 μm, preferably from 3 to 15 μm.

According to a further embodiment, layer B may be an opaque layer such as is provided in known opaque BOPP films as an opaque base layer. In this embodiment, layer B is opaque as a result of the addition of fillers. Generally, in this embodiment, layer B contains at least 70% by weight, based on the weight of layer B, of one of the partially crystalline polyolefins described hereinbefore for layer B. The filler content of the opaque layer B is preferably between 10 and 50% by weight, based on the weight of layer B. Fillers are, in the sense of the present invention, also pigments and/or vacuole-initiating particles and are known per se in the art.

Conventional pigments and/or vacuole-initiating particles are inorganic and/or organic particles such as, for example, aluminum oxide, aluminum sulfate, barium sulfate, calcium carbonate, magnesium carbonate, silicates such as aluminum silicate and magnesium silicate and silicon dioxide. The vacuole-initiating organic fillers are the polymers which are conventionally used for this purpose and are incompatible with the polymer of the base layer, in particular HDPE, copolymers of cyclic olefins such as norbornene or tetracyclododecane with ethylene or propene, polyesters, polystyrenes, polyamides, halogenated organic polymers, polyesters such as, for example, polybutylene terephthalates being preferred.

Depending on the composition of the opaque layer B, the density of the opaque layer B and thus of the film can vary within a range of from 0.4 to 1.1 g/cm³.

### Cover Layers A and E

The film according to the invention comprises, in addition to the structure consisting of the EVOH barrier layer D, the two adhesive layers C and the polyolefin layers B, cover layers which are preferably the same or different on both sides and cover the surfaces of layers B.

These polyolefinic cover layers form the external layers of the finished multi-layer film structure and determine functions such as sealing capacity, gloss, friction and, optionally after an additional treatment, properties such as imprintability, inscribability and the capacity to be metal-coated.

Examples of suitable olefinic polymers for the cover layers are polyethylenes, polypropylenes, polybutylenes or mixed polymers with olefins containing two to eight carbon atoms, copolymers or terpolymers consisting of ethylene, propylene and/or butylene units or mixtures of the aforementioned polymers being preferred.

The thickness of the respective cover layer is generally greater than 0.1 μm and is preferably in the range of from 0.5 to 10 μm.

The cover layers and/or layer B can additionally contain conventional additives such as neutralizing agents, stabilizers, antistatic agents, UV protection agents and light stabilizers, anti-blocking agents and/or lubricants in respectively effective amounts.

In a possible embodiment, the surfaces of the cover layers A and/or E are subjected to a corona, plasma or flame treatment. This treatment increases in a manner known per se adhesion to printing inks, adhesives, cold seal layers, metal layers, etc.

The overall thickness of the film according to the invention can vary within broad limits and is determined by the intended end use. It is preferably from 4 to 100 μm, in particular 5 to 80 μm, preferably 6 to 60 μm.

The invention will be described hereinafter in greater detail with reference to embodiments, wherein a person skilled in the art will be able to infer from the method conditions, materials and film properties described further details concerning the invention and the advantages thereof.

In the examples, Examples 1 to 17 describe the production of a multi-layer film which has in total seven layers and comprises an EVOH barrier layer having the above-described layer structure A/B/C/D/C/B/E, Examples 1 to 6 being comparative examples.

The materials, the commercial names of which are given in the examples, are materials of the following type:
HP 522 H: isotactic polypropylene homopolymer “Moplen®” HP 522 H from Basell;
HP 422 H: isotactic polypropylene homopolymer “Moplen®” HP 422 H (mini-random ethylene content approx. 1.5%) from Basell;
Admer® QF 551 E: anhydride-modified polypropylene resin from Mitsui Chemicals;
7372 XCP: polypropylene terpolymer “Adsyl®” 7372 XCP from Basell;
5C37 F: polypropylene terpolymer “Adsyl®” 5C37F from Basell;
MA 0935 PP: polypropylene master batch comprising 50% hydrocarbon from Constab;
LC101 B: ethylene vinyl alcohol copolymer “EVAL™” LC 101 B having an ethylene content of 27 [mol %] from EVAL EUROPE
F101 B: ethylene vinyl alcohol copolymer “EVAL™” F 101 B having an ethylene content of 32 [mol %] from EVAL EUROPE
H101 B: ethylene vinyl alcohol copolymer “EVAL™” H 101 B having an ethylene content of 38 [mol %] from EVAL EUROPE
ES104 B: ethylene vinyl alcohol copolymer “EVAL™” ES 104 B having an ethylene content of 44 [mol %] from EVAL EUROPE
G 156 B: ethylene vinyl alcohol copolymer “EVAL™” G 156 B having an ethylene content of 48 [mol %] from EVAL EUROPE
SP 482 B: ethylene vinyl alcohol copolymer “EVAL™” SP 482 B having an ethylene content of 32 [mol %] from EVAL EUROPE

### EXAMPLES

### Before Example 1

In the examples, seven-layered barrier multi-layer films comprising an EVOH layer as the inner layer were produced, extrusion being carried out through a seven-layered slot melt die onto a chill roll and the seven-layered primary film formed on the chill roll was immediately simultaneously drawn on a Laboratoriums-LISIM® drawing unit from Bruckner as specified in the examples.

The layer arrangement A/B/C/D/C/B/E of the melts for producing the multi-layer film was in this case produced using the following die arrangement comprising the specified conveyance means:

layer A—outer layer, air knife side: 43 mm single-screw extruder;

layer B—intermediate layers: 55 mm twin-screw extruder with melt pump;

layer C—adhesive layers: 35 mm single-screw extruder with melt pump;

layer D—EVOH core layer: 35 mm single-screw extruder with melt pump;

layer E—outer layer, chill roll side: 50 mm single-screw extruder

It should be noted that the naming of layers A to E is defined by the arrangement of the slot dies for the melt extrusion or the position thereof relative to the chill roll and the opposing air knife.

In Examples 1 to 6, which are comparative examples, the seven-layered barrier multi-layer film comprising an EVOH layer as the inner layer is oriented under conditions such as were optimized for the simultaneous orientation of biaxially oriented polypropylene films (s-BOPP films). Optimized conditions yield BOPP films having a combination of the desired mechanical and visual properties in conjunction with good thickness tolerances and the operational reliability required to ensure economical production. The drawing temperatures using standard polypropylene homopolymers are in the range of from 150 to 160° C., preferably at 155° C.

In Examples 7 to 17 according to the invention, the seven-layered barrier multi-layer film comprising an EVOH layer as the inner layer is drawn at temperatures of below 145° C., in particular below 140° C. and preferably at about 135° C. Reducing the drawing temperature requires modification of layer B such as may be achieved by the use of the lower layer B and the materials described in Examples 7 to 17.

### Example 1 (Comparative Example)

The materials and the operating conditions for the give extruders were as follows:

layer A: 5C37 F; extruder having an extrusion temperature of 240° C.

layer B: HP 522 H; extruder having an extrusion temperature of 258° C.

layer C: Admer QF 551 E; extruder having an extrusion temperature of 236° C.

layer D: G 156 B: extruder having an extrusion temperature of 186° C.

layer E: 5C37 F; extruder having an extrusion temperature of 240° C.

The primary film obtained after coextrusion of the seven-layered melt was oriented under conditions such as were optimized for the simultaneous orientation of biaxially oriented polypropylene films (S-BOPP films), with drawing seven times in the machine direction (MD) and drawing six times in the transversal direction (TD), in accordance with the increase in size of a lattice printed onto the base film prior to drawing. The drawing temperature in the drawing zone was 158° C. There was 5% relaxation in the longitudinal direction and 5% relaxation in the transversal direction.

A film having an overall thickness of 20 μm was obtained and the thickness of the EVOH layer (layer D) was about 1.4 μm.

The film obtained had a brilliant appearance and contained no network structure.

The tensile strength was 241 N/mm² longitudinally and 187 N/mm² transversally.

The modulus of elasticity was 2,471 N/mm² longitudinally and 1,929 N/mm² transversally. The elongation at tear was 93% longitudinally and 143% transversally.

The turbidity had a value of 1.0%. The gloss was 91.

At 120° C. and after 5 min, the shrinkage was 4.1% longitudinally and 3.1% transversally.

However, the oxygen barrier was just 81.2 cm³/m² dbar.

### Example 2 (Comparative Example)

A film was produced as described in Example 1. In contrast to Example 1, 100% by weight EVAL ES 104 B having an ethylene content of 44 mol % was used in layer D.

The extrusion temperature was 223° C. The drawing temperature in the drawing zone was 156.5° C.

A film having an overall thickness of 20 μm was obtained and the thickness of the EVOH layer (layer D) was about 1.8 μm.

The film obtained had a brilliant appearance and contained no network structure.

The tensile strength was 238 N/mm² longitudinally and 193 N/mm² transversally.

The modulus of elasticity was 2,480 N/mm² longitudinally and 2,090 N/mm² transversally.

The elongation at tear was 95% longitudinally and 134% transversally.

The turbidity had a value of 0.95%.

The gloss was 91.

At 120° C. and after 5 min, the shrinkage was 4.3% longitudinally and 4.1% transversally.

However, the oxygen barrier was just 62.7 cm³/m² dbar.

### Example 3 (Comparative Example)

A film was produced as described in Example 1. In contrast to Example 1, 100% by weight EVAL H 101 B having an ethylene content of 38 mol % was used in layer D.

The extrusion temperature was 208° C. The drawing temperature in the drawing zone was 155.5° C. The drawing ratio was 7 in the machine direction, 6.5 in the transversal direction.

A film having an overall thickness of 20 μm was obtained and the thickness of the EVOH layer (layer D) was about 1.7 μm.

The film obtained had a turbid appearance and contained a strong network structure.

### Example 4 (Comparative Example)

A film was produced as described in Example 1. In contrast to Example 1, 100% by weight EVAL F 101 B having an ethylene content of 32 mol % was used in layer D.

The extrusion temperature was 208° C. The drawing temperature in the drawing zone was 158.5° C. The drawing ratio was 7 in the machine direction, 6 in the transversal direction.

A film having an overall thickness of 20 μm was obtained and the thickness of the EVOH layer (layer D) was about 1.7 μm.

The film obtained had a turbid appearance and contained a strong network structure.

### Example 5 (Comparative Example)

A film was produced as described in Example 1. In contrast to Example 1, 100% by weight EVAL LC 101 B having an ethylene content of 27 mol % was used in layer D.

The extrusion temperature was 207° C. The drawing temperature in the drawing zone was 156.5° C. The drawing ratio was 7 in the machine direction, 6.7 in the transversal direction.

A film having an overall thickness of 18 μm was obtained and the thickness of the EVOH layer (layer D) was about 1.1 μm.

The film obtained had a turbid appearance and contained a strong network structure.

### Example 6 (Comparative Example)

A film was produced as described in Example 1. In contrast to Example 1, 100% by weight EVAL SP 482 B having an ethylene content of 32 mol % was used in layer D. This new type of EVAL was intended to ensure an improved visual appearance with an attractive barrier.

The extrusion temperature was 207° C. The drawing temperature in the drawing zone was 157.5° C. The drawing ratio was 7 in the machine direction, 6.2 in the transversal direction.

A film having an overall thickness of 15.5 μm was obtained and the thickness of the EVOH layer (layer D) was about 1.2 μm.

The film obtained had a slightly turbid appearance. The film displayed small dots but no network structure.

However, the oxygen barrier was just 185 cm³/m² dbar.

### Example 7

A film was produced as described in Example 1. In contrast to Example 1, 100% by weight EVAL H 101 B having an ethylene content of 38 mol % was used in layer D.

The extrusion temperature was 226° C. In layer B, a blend of 50% by weight HP 522 H (polypropylene homopolymer) and 50% by weight 7372 XCP (polypropylene terpolymer) was used. This allowed the drawing temperature in the drawing zone to be reduced to 137.5° C. The drawing ratio was 6 in the machine direction, 5.8 in the transversal direction.

A film having an overall thickness of 19 μm was obtained and the thickness of the EVOH layer (layer D) was about 1.7 μm.

The film obtained had a brilliant appearance and contained no network structure.

The tensile strength was 210 N/mm longitudinally and 179 N/mm² transversally.

The modulus of elasticity was 1,830 N/mm² longitudinally and 1,638 N/mm² transversally.

The elongation at tear was 84% longitudinally and 93% transversally.

The turbidity had a value of 1.8%. The gloss was 89.

At 120° C. and after 5 min, the shrinkage was 13.2% longitudinally and 14.1% transversally.

The oxygen barrier was 6.2 cm³/m² dbar.

### Example 8

A film was produced as described in Example 1. In contrast to Example 1, 100% by weight EVAL F 101 B having an ethylene content of 32 mol % was used in layer D. The extrusion temperature was 218° C.

In layer B, a blend of 50% by weight HP 522 H (polypropylene homopolymer) and 50% by weight 7372 XCP (polypropylene terpolymer) was used. This allowed the drawing temperature in the drawing zone to be reduced to 137° C. The drawing ratio was 6 in the machine direction, 6 in the transversal direction.

A film having an overall thickness of 19 μm was obtained and the thickness of the EVOH layer (layer D) was about 1.4 μm.

The film obtained had a brilliant appearance and contained no network structure.

The tensile strength was 181 N/mm² longitudinally and 204 N/mm² transversally.

The modulus of elasticity was 1,591 N/mm² longitudinally and 1,739 N/mm² transversally.

The elongation at tear was 87% longitudinally and 77% transversally.

The turbidity had a value of 2.0%. The gloss was 89. At 120° C. and after 5 min, the shrinkage was 14.1% longitudinally and 15.5% transversally.

The oxygen barrier was 3.0 cm³/m² dbar.

### Example 9

A film was produced as described in Example 1. In contrast to Example 1, 100% by weight EVAL F 101 B having an ethylene content of 32 mol % was used in layer D. The extrusion temperature was 218° C.

In layer B, a blend of 60% by weight HP 522 H (polypropylene homopolymer) and 40% by weight 7372 XCP (polypropylene terpolymer) was used. This allowed the drawing temperature in the drawing zone to be reduced to 138.5° C. The drawing ratio was 7 in the machine direction, 5.8 in the transversal direction.

A film having an overall thickness of 16.5 μm was obtained and the thickness of the EVOH layer (layer D) was about 1.3 μm.

The film obtained had a brilliant appearance and contained no network structure.

The tensile strength was 253 N/mm² longitudinally and 170 N/mm² transversally.

The modulus of elasticity was 2,408 N/mm² longitudinally and 1,772 N/mm² transversally.

The elongation at tear was 62% longitudinally and 98% transversally.

The turbidity had a value of 2.1%. The gloss was 88.

At 120° C. and after 5 min, the shrinkage was 14.0% longitudinally and 11.1% transversally.

The oxygen barrier was 3.0 cm³/m² dbar.

### Example 10

A film was produced as described in Example 1. In contrast to Example 1, 100% by weight EVAL F 101 B having an ethylene content of 32 mol % was used in layer D. The extrusion temperature was 218° C.

In layer B, a blend of 60% by weight HP 522 H (polypropylene homopolymer) and 40% by weight 7372 XCP (polypropylene terpolymer) was used. This allowed the drawing temperature in the drawing zone to be reduced to 137.5° C. The drawing ratio was 6 in the machine direction, 5.8 in the transversal direction.

A film having an overall thickness of 20 μm was obtained and the thickness of the EVOH layer (layer D) was about 1.6 μm. There was 15% relaxation in the longitudinal direction and 15% relaxation in the transversal direction.

The film obtained had a brilliant appearance and contained no network structure.

The tensile strength was 217 N/mm² longitudinally and 156 N/mm² transversally.

The modulus of elasticity was 1,929 N/mm² longitudinally and 1,572 N/mm² transversally.

The elongation at tear was 82% longitudinally and 116% transversally.

The turbidity had a value of 2.2%. The gloss was 85.

At 120° C. and after 5 min, the shrinkage was 5.1% longitudinally and 4.8% transversally.

The oxygen barrier was 3.3 cm³/m² dbar.

### Example 11

A film was produced as described in Example 1. In contrast to Example 1, 100% by weight EVAL F 101 B having an ethylene content of 32 mol % was used in layer D. The extrusion temperature was 218° C.

In layer B, a blend of 80% by weight HP 522 H (polypropylene homopolymer) and 20% by weight 7372 XCP (polypropylene terpolymer) was used. This allowed the drawing temperature in the drawing zone to be reduced to 135.0° C. The drawing ratio was 7 in the machine direction, 5.8 in the transversal direction.

A film having an overall thickness of 17 μm was obtained and the thickness of the EVOH layer (layer D) was about 1.4 μm.

The film obtained had a brilliant appearance and contained no network structure.

The tensile strength was 269 N/mm² longitudinally and 187 N/mm² transversally. The modulus of elasticity was 2,618 N/mm² longitudinally and 2,063 N/mm² transversally. The elongation at tear was 65% longitudinally and 87% transversally.

The turbidity had a value of 2.2%. The gloss was 83.

At 120° C. and after 5 min, the shrinkage was 14.0% longitudinally and 10.2% transversally.

The oxygen barrier was 3.0 cm³/m² dbar.

### Example 12

A film was produced as described in Example 1. In contrast to Example 1, 100% by weight EVAL LC 101 B having an ethylene content of 27 mol % was used in layer D. The extrusion temperature was 217° C.

In layer B, a blend of 80% by weight HP 522 H (polypropylene homopolymer) and 20% by weight 7372 XCP (polypropylene terpolymer) was used. This allowed the drawing temperature in the drawing zone to be reduced to 136.0° C. The drawing ratio was 7 in the machine direction, 5.8 in the transversal direction.

A film having an overall thickness of 16.4 μm was obtained and the thickness of the EVOH layer (layer D) was about 1.4 μm.

The film obtained had a brilliant appearance and contained no network structure.

The tensile strength was 260 N/mm² longitudinally and 189 N/mm² transversally. The modulus of elasticity was 2,547 N/mm² longitudinally and 2,092 N/mm² transversally. The elongation at tear was 64% longitudinally and 85% transversally.

The turbidity had a value of 1.7%. The gloss was 88.

At 120° C. and after 5 min, the shrinkage was 11.6% longitudinally and 9.6% transversally.

The oxygen barrier was 2.3 cm³/m² dbar.

### Example 13

A film was produced as described in Example 1. In contrast to Example 1, 100% by weight EVAL LC 101 B having an ethylene content of 27 mol % was used in layer D. The extrusion temperature was 217° C.

In layer B, a blend of 80% by weight HP 522 H (polypropylene homopolymer) and 20% by weight 7372 XCP (polypropylene terpolymer) was used. This allowed the drawing temperature in the drawing zone to be reduced to 136.0° C. The drawing ratio was 6.3 in the machine direction, 5.2 in the transversal direction. There was 15% relaxation in the longitudinal direction and 15% relaxation in the transversal direction.

A film having an overall thickness of 21.0 μm was obtained and the thickness of the EVOH layer (layer D) was about 1.7 μm.

The film obtained had a brilliant appearance and contained no network structure.

The tensile strength was 225 N/mm² longitudinally and 159 N/mm² transversally. The modulus of elasticity was 2,133 N/mm² longitudinally and 1,868 N/mm² transversally. The elongation at tear was 85% longitudinally and 97% transversally. The turbidity had a value of 1.6%. The gloss was 89. At 120° C. and after 5 min, the shrinkage was 3.0% longitudinally and 3.1% transversally.

The oxygen barrier was 2.0 cm³/m² dbar.

### Example 14

A film was produced as described in Example 1. In contrast to Example 1, 100% by weight EVAL F 101 B having an ethylene content of 32 mol % was used in layer D. The extrusion temperature was 217° C.

In layer B, a blend of 80% by weight HP 522 H (polypropylene homopolymer) and 20% by weight 7372 XCP (polypropylene terpolymer) was used. This allowed the drawing temperature in the drawing zone to be reduced to 136.5° C. The drawing ratio was 6 in the machine direction, 5.3 in the transversal direction. There was 15% relaxation in the longitudinal direction and 15% relaxation in the transversal direction.

A film having an overall thickness of 20.0 μm was obtained and the thickness of the EVOH layer (layer D) was about 1.7 μm.

The film obtained had a brilliant appearance and contained no network structure.

The tensile strength was 231 N/mm² longitudinally and 168 N/mm² transversally. The modulus of elasticity was 2,118 N/mm² longitudinally and 1,807 N/mm² transversally. The elongation at tear was 88% longitudinally and 107% transversally. The turbidity had a value of 1.5%. The gloss was 89. At 120° C. and after 5 min, the shrinkage was 3.3% longitudinally and 1.9% transversally.

The oxygen barrier was 2.8 cm³/m² dbar.

### Example 15

A film was produced as described in Example 1. In contrast to Example 1, 100% by weight EVAL H 101 B having an ethylene content of 38 mol % was used in layer D. The extrusion temperature was 218° C.

In layer B, a blend of 80% by weight HP 522 H (polypropylene homopolymer) and 20% by weight 7372 XCP (polypropylene terpolymer) was used. This allowed the drawing temperature in the drawing zone to be reduced to 136.0° C. The drawing ratio was 7 in the machine direction, 6 in the transversal direction.

A film having an overall thickness of 16.0 μm was obtained and the thickness of the EVOH layer (layer D) was about 1.3 μm.

The film obtained had a brilliant appearance and contained no network structure.

The tensile strength was 264 N/mm² longitudinally and 200 N/mm² transversally. The modulus of elasticity was 2,526 N/mm² longitudinally and 1,998 N/mm² transversally. The elongation at tear was 73% longitudinally and 99% transversally. The turbidity had a value of 1.4%. The gloss was 90. At 120° C. and after 5 min, the shrinkage was 9.9% longitudinally and 8% transversally.

The oxygen barrier was 8.2 cm³/m² dbar.

### Example 16

A film was produced as described in Example 1. In contrast to Example 1, 100% by weight EVAL LC 101 B having an ethylene content of 27 mol % was used in layer D. The extrusion temperature was 218° C.

In layer B, 100% by weight HP 422 H (polypropylene mini-random ethylene content 1.5%) was used. This allowed the drawing temperature in the drawing zone to be reduced to 135.0° C. The drawing ratio was 6 in the machine direction, 6 in the transversal direction.

A film having an overall thickness of 17.0 μm was obtained and the thickness of the EVOH layer (layer D) was about 1.5 μm.

The film obtained had a brilliant appearance and contained no network structure.

The tensile strength was 224 N/mm² longitudinally and 210 N/mm² transversally. The modulus of elasticity was 2,376 N/mm² longitudinally and 2,376 N/mm² transversally. The elongation at tear was 76% longitudinally and 75% transversally. The turbidity had a value of 0.95%. The gloss was 91. At 120° C. and after 5 min, the shrinkage was 7.6% longitudinally and 7.4% transversally.

The oxygen barrier was 1.8 cm³/m² dbar.

### Example 17

A film was produced as described in Example 1. In contrast to Example 1, 100% by weight EVAL LC 101 B having an ethylene content of 27 mol % was used in layer D. The extrusion temperature was 218° C.

In layer B, a blend of 90% by weight HP 422 H and 10% by weight MA 0935 PP (polypropylene master batch comprising 50% hydrocarbon) was used. This allowed the drawing temperature in the drawing zone to be reduced to 135.0° C.

The drawing ratio was 6 in the machine direction, 6.2 in the transversal direction.

A film having an overall thickness of 17.5 μm was obtained and the thickness of the EVOH layer (layer D) was about 1.5 μm.

The film obtained had a brilliant appearance and contained no network structure.

The tensile strength was 231 N/mm² longitudinally and 195 N/mm² transversally. The modulus of elasticity was 2,807 N/mm² longitudinally and 2,626 N/mm² transversally. The elongation at tear was 77% longitudinally and 77% transversally. The turbidity had a value of 0.93%. The gloss was 92. At 120° C. and after 5 min, the shrinkage was 7.2% longitudinally and 6.8% transversally.

The oxygen barrier was 1.7 cm³/m² dbar.

### SUMMARY OF THE RESULTS

The results of the film production tests described in the examples clearly reveal that, in accordance with the present invention, BOPP films comprising EVOH barrier layers having outstanding barrier properties and a combination of further excellent properties which are desirable for use in packaging are obtained, very good film strength, film rigidity, outstanding visual properties being combined with outstanding properties with respect to aroma and odor tightness and other outstanding barrier properties. It is also possible to combine barrier properties with shrinkage properties.

The scope of the production conditions specified in the examples is restricted merely by the equipment available during the tests, although the specific method conditions indicated do not define the limits of the present invention or of the method of producing the films according to the invention. Depending on the intended uses of the films, barrier thicknesses of up to 10 μm can, for example, be obtained if that is deemed to be desirable.

It should also be noted that the conditions of the simultaneous drawing can be controlled in such a way that the films obtained are stabilized, so they have dimensional stability in which, in one or both of their main directions which correspond to the MD and TD of their manufacture, shrinkage of 5% or less is obtained. However, the drawing conditions may also be selected in such a way that the shrinkage in one or both directions is at 120° C. more than 15%.

It should also be noted that, in the case of the seven-layered structure, one of the polypropylene layers of layers B can also be produced using regenerated polypropylene or using polyolefins which differ from polypropylene used for the other layer B, depending on the end use.

Owing to their outstanding barrier properties, the films are suitable for all packaging uses in which the packaged product may not lose any aroma and/or no odors may be allowed to pass through the packaging. The low oxygen transmission rate and the low water vapor transmission rate of the films according to the invention are such that they are suitable for most uses for which the more expensive BOPP films coated with PVOH or PVDC have currently to be used.

Particularly preferred uses are uses for the packaging of foods, for example fresh foods, sweets and confectionery. The films can also be used for packaging other goods, for example pharmaceuticals. Owing to their good visual properties, the films can also be used for all applications in which consumers expect transparent barrier materials.

1. A barrier film for use in packaging, particularly for the packaging of foods and luxury products, in the form of a multi-layer film based on a biaxially oriented polyolefin film having at least one coextruded functional layer or barrier based on ethylene-vinyl alcohol copolymers (EVOR), wherein it is produced by simultaneous drawing of a coextruded multi-layer primary film, the thickness of the EVOR layer is less than 5 μm, in particular less than 2 μm, and the values for the oxygen transmission rate at 23° C. and 75% relative humidity (OTR; ASTM) are lower than 10 cm³/m² dbar, preferably lower than 5 cm³/m² dbar.

2. The film as claimed in claim 1, wherein it has at least five layers and a layer structure B/O/D/C/B, the two layers B being structural layers based on biaxially oriented polyolefins, the two layers C each being adhesion promoter layers based on modified polyolefins and layer D being a barrier layer based on an EVOH copolymer having a molar ethylene content of 40 mol % or less.

3. The film as claimed in claim 2, wherein it has seven layers and a layer structure A/B/C/D/C/B/E, the additional layers A and E, which may be the same or different, being functional cover layers made of modified polyolefins for achieving a desired sealing capacity, improvement in adhesion, desired friction and gloss values and/or for ensuring imprintability, inscribability or the capacity to be metal-coated.

4. The film as claimed in claim 1, wherein the modified polyolefin of the adhesion promoter layers C is a polypropylene or polyethylene modified by maleic anhydride.

5. The film as claimed in claim 1, wherein the adhesion promoter layers C each have a thickness in the range of from 0.1 to 5 μm.

6. The film as claimed in claim 1, wherein the polyolefin of at least one of layers B is a partially crystalline thermoplastic polypropylene which, at temperatures of 145° C. and therebelow, is biaxially oriented by simultaneous drawing and/or a modified polypropylene.

7. The film as claimed in claim 6, wherein the partially crystalline thermoplastic polypropylene of layers B is a modified polypropylene which is based on an isotactic propylene homopolymer, propylene copolymer or propylene terpolymer and preferably comprises at least from 80 to 98% by weight of propylene units and a corresponding remainder of ethylene and/or butylene units.

8. The film as claimed in claim 6, wherein the polypropylene of layer(s) B contains a modifier selected from atactic polypropylene, syndiotactic polypropylene, hydrocarbon resin, ethylene-propylene copolymer, propylene-butylene copolymer, ethylenepropylene-butylene terpolymer, polybutylene, regenerated polypropylene and linear low-density polyethylene (PE-LLD) and mixtures thereof.

9. The film as claimed in claim 1, wherein at least one of layers B additionally contains vacuole-initiating fillers and/or pigments and is colored or opaque.

10. The film as claimed in claim 1, wherein the thickness of layers B is respectively in the range of from 3 to 35 μm, preferably 3 to 15 μm.

11. The film as claimed in claim 1, wherein the tensile strength of the film and its modulus of elasticity in the machine direction (MD) and its elongation at tear in the transversal direction (TD) are the same or greater than in the TD and MD respectively.

12. The film as claimed in claim 1, wherein the sum of the moduli of elasticity in the longitudinal and transversal directions exceeds 2,000 N/mm², preferably 4,000 N/mm².

13. The film as claimed in claim 1, wherein it has a gloss (gloss; ASTM 2457) above 80.

14. The film as claimed in claim 1, wherein it is a film containing no fillers or pigments and has a turbidity (turbidity; ASTM 1003) below 5%.

15. The film as claimed in claim 1, wherein it is a shrink film and has at 120° C. within 5 min shrinkage of at least 10% in one or both main directions of the film.

16. The film as claimed in claim 1, wherein the thickness of the film is in the range of from 4 to 100 μm.

17. The film as claimed in claim 1, wherein the film is metal-coated on at least one surface.

18. The film as claimed in claim 1, wherein it is obtainable using a method of producing a barrier film for use in packaging.

19. A method of producing a barrier film for use in packaging as claimed in claim 1, wherein the polymers forming the layers of the multi-layer film are coextruded as melts from the requisite number of slot dies onto a chill roll and the primary multi-layer film which is formed is subjected to contactless simultaneous drawing, the surface area increasing by at least ten times, on a simultaneous drawing unit at drawing temperatures of 145° C. or therebelow, preferably of 140° C. or therebelow, strain rates of more than 50%/s, preferably of more than 300%/s, being applied.

20. The method as claimed in claim 19, wherein the primary multi-layer film is drawn in the longitudinal and transversal directions to at least three times its initial dimensions.

21. The method as claimed in claim 19, wherein the simultaneous drawing is carried out as drawing of a flat film on a simultaneous drawing unit with linear motor operation (LISIM®).

22. A use of a barrier film as claimed in claim 1, as an aroma, odor and oxygen-tight packaging film for foods and luxury products.

23. A use of a barrier film as claimed in claim 1, as a lid film.
